(19) United States
(12) Patent Application Publication
(10) Pub. No.: US 2005/0282057 A1
(43) Pub. Date: Dec. 22, 2005

(54) Fuel cell apparatus

(76) Inventors: Frank Brenner, Remseck (DE); Ulrich Gottwick, Stuttgart (DE); Rainer Saliger, Bamberg (DE); Jan-Michael Graehn, Stuttgart (DE); Norbert Schmidt, Stuttgart (DE)

Correspondence Address: STRIKER, STRIKER & STENBY, 103 EAST NECK ROAD, HUNTINGTON, NY, 11743, US

(21) Appl. No.: 11/150,998

(22) Filed: Jun. 13, 2005

(30) Foreign Application Priority Data
Jun. 19, 2004 (DE) 10 2004 029840.8

(51) Int. Cl. H01M 2/00

(52) U.S. Cl. 429/34

(57) ABSTRACT

A fuel cell apparatus has a diaphragm located between the anode and cathode sides of a fuel cell. At least one pressure compensation element (10, 20) is provided, which limits the differential pressure acting on the diaphragm (5).

### BACKGROUND OF THE INVENTION

The invention relates generally to a fuel cell apparatus.

Fuel cells are operated with a diaphragm, which is one of its operating devices and which separates its anode and cathode sides. However, if the diaphragm is damaged, detonating gas reactions will occur, with the familiar adverse effects thereof.

One possible reason for damage to the diaphragms is pressure fluctuations in the system. Pressure compensation for electrochemical cells is disclosed in U.S. Pat. No. 5,693,202. The technical teaching disclosed in that patent, however, involves a hydrostatic pressure equilibrium, which does not appear suitable for use in the fuel cell field.

### SUMMARY OF THE INVENTION

The object of the invention is to increase the safety of operation of a fuel cell apparatus. To overcome the aforementioned problem, according to the present invention a fuel cell apparatus is proposed, including a fuel cell having a diaphragm separating an anode side and a cathode side, and having one inlet and one outlet for an anode gas and one inlet and one outlet for a cathode gas. At least one pressure compensation element is provided, which limits a differential pressure acting on the diaphragm.

A pressure compensation element of this kind, in the event of a sudden pressure drop on the anode or cathode side of the fuel cell, prevents the diaphragm located between them from being stressed on one side by the abruptly rising differential pressure and possibly becoming damaged or even destroyed.

In a preferred embodiment, the at least one pressure compensation element is located on the inlet side and/or the outlet side of the fuel cell. As a result, a small structural unit can be located as the pressure compensation element over short connecting paths and requires hardly any additional space for accommodating the fuel cell.

In a modified embodiment, at least one pressure compensation element is located between one of the inlets and one of the outlets. Such an arrangement may be advantageous, for instance under special operating conditions, or perhaps when special situations in terms of space are involved.

In a special embodiment, the at least one pressure compensation element is embodied as a cylinder, with a piston guided in it in pressure-dependent fashion for controlling the effective cross section of an outlet opening. This embodiment has the advantage of containing only passive elements, which given a suitable design, assure a very rapid response behavior of the pressure compensation element.

In a next embodiment, two pressure-effective faces, separated from one another, are embodied on the piston. The pressure compensation element is thus independent of the absolute pressure and can react immediately to any pressure change that affects one side or affects both sides to different extents.

In a preferred embodiment, for regulating the effective cross section of an outlet opening, the effective piston faces are the same size. This embodiment is advantageous if both sides of the supply line have the same cross section.

In an embodiment modified from the above, it is also advantageous that for regulating the effective cross section of an outlet opening, the effective piston faces are different sizes. This embodiment is advantageous whenever different cross sections in the supply lines, or when, for instance, operational needs require different sensitivities in the response behavior.

In a special embodiment, the pressure compensation element is spring-loaded. A simpler construction of the pressure element can be implemented as a result.

In a particularly preferred embodiment, the pressure compensation element is embodied as a pressure scale. This embodiment may be provided both for pistons with effective piston faces of the same size and pistons with effective piston faces of different sizes. Depending on the pressure conditions involved, this embodiment functions in such a way that the piston is acted upon by the resultant forces from two diametrically opposite sides. Depending on the prevailing differential pressure, the piston is displaced on one side or the other, until the outlet opening is perhaps opened, either partially or even completely, until such time as the differential pressure has dropped to its permissible maximum value.

In a special embodiment, the pressure compensation element is embodied such that the effective cross section for the outlet function is at least as large as the larger of the two effective cross sections of the two delivery sides, if one is larger than the other. This assures that a pressure increase in the fuel cell cannot be caused by a dynamic pressure that might otherwise occur.

In a next embodiment, the pressure compensation element is controllable or regulatable with regard to its reaction time. As a result, fluctuations in the system can be avoided.

In a next embodiment, the pressure compensation element is controllable or regulatable with regard to its pressure sensitivity. By this provision as well, positive influence can be exerted on the vibration behavior of the system.

In a next embodiment, the pressure compensation element is controllable or regulatable with regard to its damping property. This property likewise has a positive effect on the vibration behavior of the system.

In a next embodiment, the pressure compensation element has a sensor and an actuator. Because of the embodiment as an active pressure compensation element, the possibility exists of influencing its parameterization even retroactively, which is advantageous particularly whenever space is structurally tight, or if, for instance in experimental phases of fuel cell operation, parameters have to be changed frequently.

In principle, the provision is understood also to apply for fuel cell stacks, and not merely for individual fuel cells. To prevent damage to the fuel cell, the side affected by the overpressure can be opened briefly, until further provisions come into play, so that the overpressure can dissipate into the open air or into a suitable volume.

One exemplary embodiment of the invention is shown in the drawings and will be described in further detail below in conjunction with them.

### BRIEF DESCRIPTION OF THE DRAWINGS

FIG. 1 is a schematic illustration of a fuel cell apparatus, with a diaphragm separating the anode and cathode sides, with inlets and outlets for anode gas and cathode gas, and with pressure compensation elements connecting them for limiting the differential pressure;

FIG. 2 shows a pressure compensation element in the position of repose, with an equalized pressure ratio P1=P2;

FIG. 3 shows a pressure compensation element in the working position, at an unequal pressure P1>P2, in which ΔP becomes so great that the outlet is opened; and

FIG. 4 is a schematic illustration of a fuel cell apparatus, with one pressure compensation element between each inlet and a respective outlet.

### DESCRIPTION OF THE PREFERRED EMBODIMENT

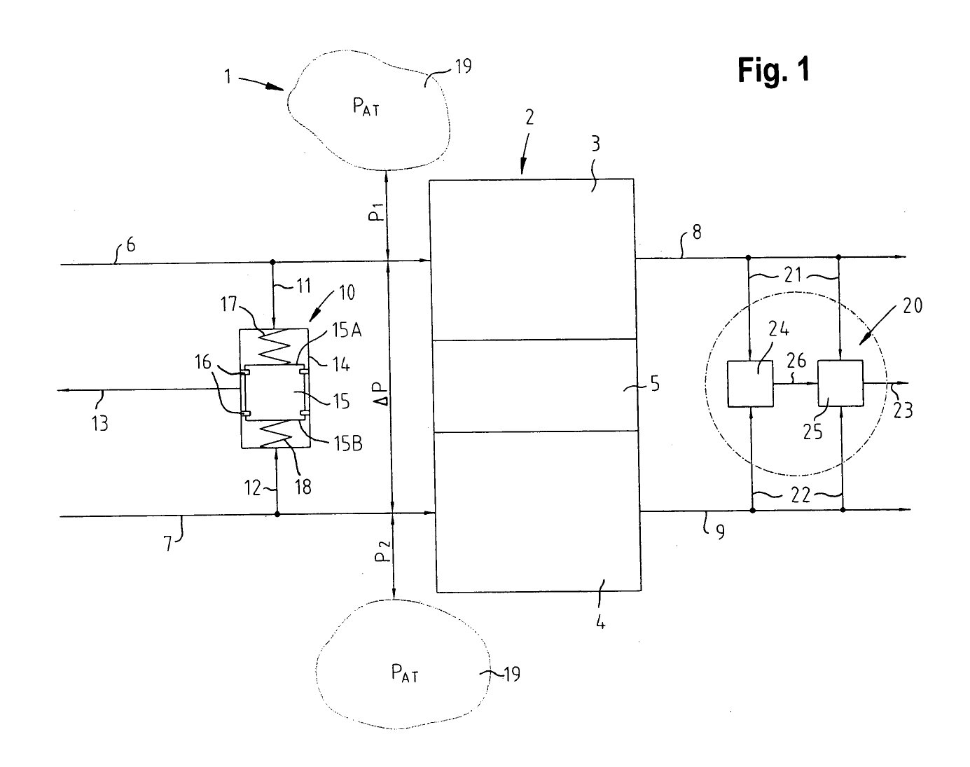

FIG. 1 shows as an example a schematic illustration of a fuel cell apparatus 1 with a fuel cell 2 and with pressure compensation elements 10, 20 located parallel to the fuel cell 2.

In principle, in pure H₂ systems, the fuel cell systems are operated in the dead-end mode; as a rule, nothing is expelled again. Only upon purging (scavenging) is something sometimes drained out, because of inert gas.

In the present example, the fuel cell 2 is supplied with a gas via the inlet 6, and this gas leaves the fuel cell 2 again via the outlet 8. The cathode gas is delivered to the fuel cell 2 via the inlet 7 and leaves the fuel cell through the outlet 9. Between the anode 3 and the cathode 4, there is a diaphragm 5, which is exposed to the differential pressure between the anode gas and the cathode gas.

Conventional fuel cells are at present operated with a pressure level of up to 3 bar. The diaphragms located in the fuel cells are designed, for instance, for a differential pressure of up to 500 mbar.

To limit the differential pressure ΔP that occurs upon a sudden pressure drop in the anode gas or cathode gas and that acts on the diaphragm 5, it is provided according to the invention that a pressure compensation element 10, 20 be located between the anode side 6, 8 and the cathode side 7, 9 of the fuel cell 2.

The pressure conditions are shown in FIG. 1 such that atmospheric pressure 19 (P_{AT}) is the reference pressure for the pressure P1 of the anode gas and for the pressure P2 of the cathode gas. The differential pressure ΔP prevails between the pressure P1 and the pressure P2.

As an example, in FIG. 1 a passive pressure compensation element 10 is shown in the inlet region of the fuel cell 2. On the anode side, it communicates with the connection 11 in a way that carries both pressure and volume, and on the cathode side, it communicates with the connection 12. When a differential pressure ΔP>0 occurs, the piston 15 is displaced in the cylinder 14 out of its position of repose, and if the differential pressure is high enough, opens the outlet 13. The seals 16 assure the mutual sealing of the two piston chambers on the anode gas and cathode gas sides, in which the effective piston faces 15A, 15B are located. Even if there is leakage occurring from a defective seal, the two gases always remain separate, because of the separate location of the seals.

In addition to the effective piston face 15A, a spring 17 is located in the anode gas region of the pressure compensation element 10, for acting on the piston; it is located diametrically opposite a spring 18 in the region of the cathode gas side.

An example for a passive pressure compensation element could be as follows:

The piston diameter, for instance, may have an area of 10 cm²; let it be assumed that the differential pressure is abruptly 500 mbar. The accelerating force is thus approximately 50 N. For a piston mass of 200 g, an acceleration of approximately 250 m/s² is thus attained. Typical distances of 5 cm are thus covered within a time on the order of magnitude of 20 ms (depending on the spring design). For twice the piston face, this time is halved. The motion of the piston thus represents an additional elasticity that compensates for pressure regulation fluctuations.

An example of an active pressure compensation element 20 is shown between the two outlets 8, 9 of the fuel cell 2. The pressure conditions, depending on the flow resistance in the fuel cell 2, are approximately the same as the pressure conditions on the inlet side. Accordingly, the pressure compensation element may be located upstream or downstream of the fuel cell.

FIG. 1 basically shows the embodiment of an active and a passive pressure compensation element only schematically. The active pressure compensation element 20 has a sensor 24 and an actuator 25. The outlet 23 is opened whenever the actuator 25, via the symbolically represented sensor-actuator connection 26, receives a corresponding signal. It is understood, however, that the actuator 25 may also be addressed from some other element, based on a signal from the sensor 24.

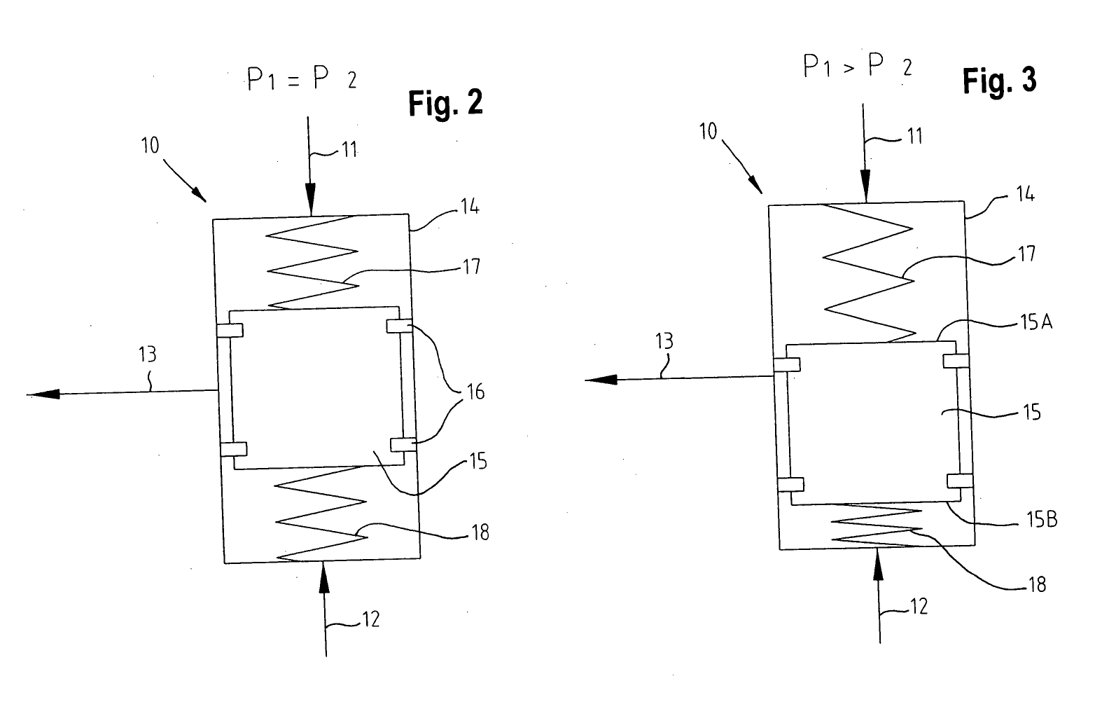

FIG. 2 schematically shows a pressure compensation element 10 in the position of repose, where P1=P2. The two springs 17, 18 are equally loaded because the pressure ratios between the anode side 11 and cathode side 12 are the same, so that the piston 50 is positioned approximately in the middle of the cylinder 14 and closes the outlet 13.

In FIG. 3, by comparison, an active position of the pressure compensation element 10 is shown, with P1>P2. In this case, an overpressure prevails on the anode side 11 compared to the cathode side 12. In this example, because of a force excess, acting on the piston face 15A counter to the spring force 18, and because of the lesser pressure force on the piston face 15B, the piston 15 is displaced so far that the outlet 13 is opened on the anode gas side.

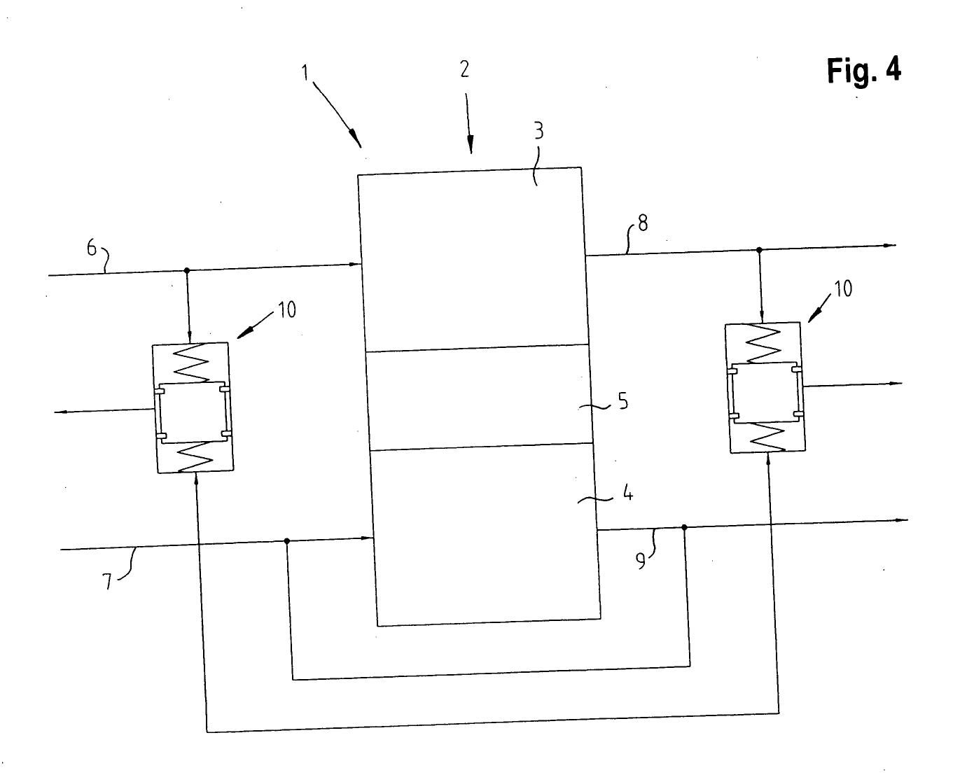

FIG. 4 schematically shows a fuel cell apparatus 1 in which pressure compensation elements 10, for example, are located crosswise between the inlets and outlets of the anode side and cathode side, respectively, of the fuel cell 2. It is understood that for securing the diaphragm 5, the provision of a single pressure compensation element 10 will suffice. However, in special embodiments, it may also be provided that there is at least one second pressure compensation element.

It is understood that a combination of arrangements of pressure compensation elements as in FIG. 1 and FIG. 4 is also possible. Combining passive and active elements is also conceivable.

The variant embodiments shown are intended only to illustrate the invention. In principle, further embodiments, such as the aforementioned combinations of different connections between the inlet and outlet sides of the anode and cathode gas lines are possible.

It will be understood that each of the elements described above, or two or more together, may also find a useful application in other types of constructions differing from the types described above.

While the invention has been illustrated and described herein as a fuel cell apparatus, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A fuel cell apparatus, comprising:
a fuel cell having a diaphragm separating an anode side and a cathode side;
one inlet and one outlet for an anode gas;
one inlet and one outlet for a cathode gas;
at least one pressure compensation element, wherein said at least one pressure compensation element limits a differential pressure acting on the diaphragm.

2. The fuel cell apparatus according to claim 1, wherein the at least one pressure compensation element is located on the inlet side and/or the outlet side.

3. The fuel cell apparatus according to claim 1, wherein the at least one pressure compensation element is located between one of the inlets and one of the outlets.

4. The fuel cell apparatus according to claim 1, wherein the at least one pressure compensation element is embodied as a cylinder, wherein a piston (15) guided is guided in the cylinder in pressure-dependent fashion for controlling an effective cross section of an outlet opening.

5. The fuel cell apparatus according to claim 1, wherein two pressure-effective faces, separated from one another, are formed on the piston.

6. The fuel cell apparatus according to claim 5, wherein for regulating an effective cross section of an outlet opening, the effective piston faces are the same size.

7. The fuel cell apparatus according to claim 5, wherein for regulating an effective cross section of an outlet opening, the effective piston faces are different sizes.

8. The fuel cell apparatus according to claim 1, wherein the pressure compensation element is spring-loaded.

9. The fuel cell apparatus according to claim 1, wherein the pressure compensation element is a pressure scale.

10. The fuel cell apparatus according to claim 1, wherein the pressure compensation element is embodied such that an effective cross section for an outlet function is at least as large as the larger of two effective cross sections of the two inlets.

11. The fuel cell apparatus according to claim 1, wherein the pressure compensation element is controllable or regulatable with regard to reaction time.

12. The fuel cell apparatus according to claim 1, wherein the pressure compensation element is controllable or regulatable with regard to pressure sensitivity.

13. The fuel cell apparatus according to claim 1, wherein the pressure compensation element is controllable or regulatable with regard to a damping property.

14. The fuel cell apparatus according to claim 1, wherein the pressure compensation element has a sensor and an actuator.
